(19) United States
(12) Patent Application Publication
(10) Pub. No.: US 2022/0371213 A1
(43) Pub. Date: Nov. 24, 2022

(54) Knife Ring

(71) Applicant: Jose Ernesto Bello Ravelo, Miami, FL (US)

(72) Inventor: Jose Ernesto Bello Ravelo, Miami, FL (US)

(21) Appl. No.: 17/835,932

(22) Filed: Jun. 8, 2022

(51) Int. Cl. B26B 27/00

(52) U.S. Cl. CPC B26B 27/007

(57) ABSTRACT

Cutting device or Multi-purpose ring:
Cutting blade, support base and arch or ring.
The ring allow to accommodate the cutting device or multi-purpose ring on the desire finger and keep it firm on the hand.
The resting base is completely flat, it's located in the center of the cutting device or multi-purpose ring, with semi-rectangular shape, the ring arch cross the base for the middle, the bottom of the base have the cutting a blade in one his sides.
The majority of the cutting blades are designed in a way that can be used for left and right handlers, the blades have different designs that respond to different uses, some blade design will have the blade in a way that the right hand ring it can't be used for left hand people, blades will be attached to a base with a ring in some versions of the Cutting device or Multi-purpose ring, blades can have infinite forms and shapes.

A cutting device or mufti-purpose ring, with multiple designs to used it in different task of everyday life, also gives us extreme security in its handling, is easy to use, transport and store, there is plastic versions that make this product the safer cutter.

### RECORD

The knife and ring are two separate design concepts with different uses.

The knives have an infinite number of patterns that serve different purposes for different applications, and can be made of different materials.

The knife is an old tool and despite the infinity of its designs even today almost all knife models have something in common.

There are rings that incorporate a cutting blade in its design and in cases parts of the ring are sharp.

Rings fulfill an ornamental function and in some cases are related to economic well-being, in other cases represent recognition but for the most part it's just part of the fashion at the moment.

### SUMMARY

Three main parts of this cutting device are, (a) ring or arch. (b) support base. (c) cutting blade.

(a) The ring or arch keeps the finger firm on the support base allowing the pressure exerted by the finger on the blade blade to be balanced and precise.

(b) Support base provides firmness, maneuverability, safety, stability, comfort and more pressure on cutting blade.

(c) The cutting blade (various designs) is located at the bottom of the cutting device or multi-purpose Ring, its design guarantees us a cutting of extreme precision and due to the shape of the blade we can make a cut prolonged or long and straight Its edge is located on the inside of the leaf and can traverse the entire blade or only what the user wants.

The design and light weight of the cutting device or multi-purpose ring allows us, using the ring, the freedom of have complete mobility in the hand of the ring.

The ring holds the finger with his arch, but it is recommended to use the index finger to hold the ring and use the thumb and middle finger to reinforce the grip.

The cutting device or multi-purpose ring can easily be placed on the finger using the thumb or index. Its removal is also easily performed with one hand, in the same way you can change the cutting device or multi-purpose finger ring without the need to use both hands, depending on the holding position of the cutting device or multipurpose ring will the affect the utility and purpose.

The cutting device have many designs that not only can peel and cut fruits, vegetables and meats, but It also open boxes, packaging and other frequent necessities in the kitchen. It can be an scraper for paint or other surfaces in the home. It also helps to squeeze lemons, lime, etc.

The unique design of this piece allows its easy use, unbeatable maneuverability, easy to clean, easy to store, and light weight, making it a convenient tool for the home too.

The base allows the finger pressure on the cutting blade to be accurate and stable at the time of cutting.

This cutting device or multi-purpose ring is a piece for the home and everyday life with multiple uses on the tip of your finger that modernizes the well-known and traditional knife.

The multi-purpose ring it's a two-piece version that allows us to exchange the cutting blade, that results in countless possibilities of utilities, besides ornamental covers for the decorative use of the piece.

The multi-purpose ring it's a two-piece version that can be used in various various jobs that don't necessarily involve cutting, like screwdrivers, tin openers, corkscrew, bottle opener, etc, becoming a very useful, convenient, easy and comfortable tool with countless features for workplace, recreational or home.

The multi-purpose ring it's a two-piece version in which the blade can have infinite forms and shapes designs that respond to different uses, while the ring only varies in size but almost never its design.

### BRIEF DESCRIPTION OF THE DRAWINGS

In order for a better understanding of the product and its use, we have made an exhibition of all the images. Later we offer a more detailed information of the invention.

FIG. 1 Front view of the cutting device, as shown in FIG. 1

FIG. 2 Rear view of the cutting device, as shown in FIG. 2

FIG. 3 Side view of the cutting device, as shown in FIG. 3

FIG. 4 Top view of the cutting device, as shown in FIG. 4

FIG. 5 Bottom view of the cutting device, as shown in FIG. 5

FIG. 6 Perspective view of the cutting device, as shown in FIG. 6

FIG. 7 Perspective view of the cutting device and side view of the cutting device as shown in FIG. 7 and FIG. 8

FIG. 8 Different models of cutting device designs, as shown in FIG. 8

FIG. 9 Different views of the two pieces of the multi-purpose ring, as shown in FIG. 9

FIG. 10 Different models of blades of the multi-purpose ring, as shown in FIG. 10

FIG. 11 View of two cutting devices or multi-purpose rings, as shown in FIG. 11

FIG. 12 Sequence view of the cutting device peeling, as shown in FIG. 12

FIG. 13 Sequence view of the cutting device opening a box as shown in FIG. 13

FIG. 14 View of different model of the cutting device, as shown in FIG. 14

FIG. 15 Assembly view of the multipurpose ring, different blades, as shown in FIG. 15

FIG. 16 Miscellaneous view of the multipurpose ring blades, as shown in FIG. 16

FIG. 17 Miscellaneous view of the multipurpose ring blades, as shown in FIG. 17

FIG. 18 Miscellaneous view of the multipurpose ring blades, as shown in FIG. 18

### DETAILED DESCRIPTION OF THE DRAWINGS

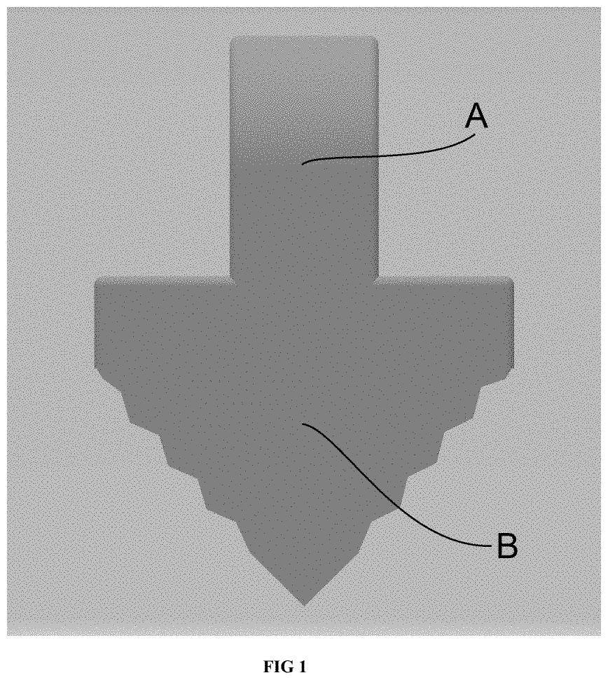

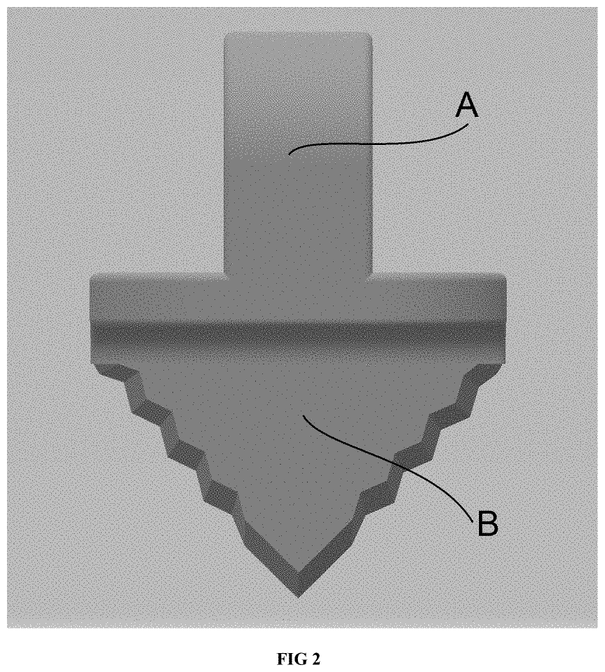

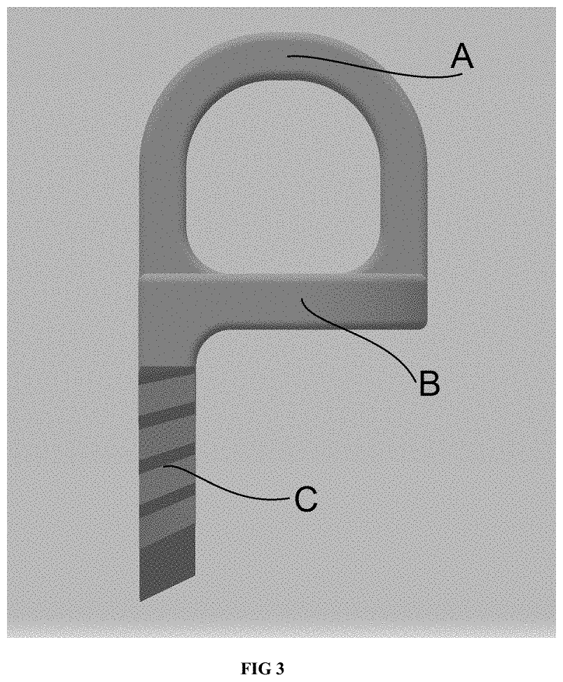

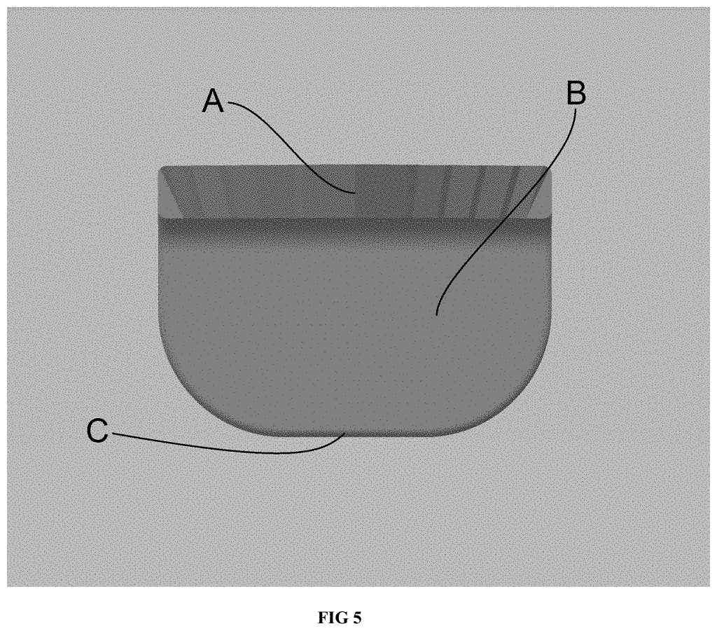

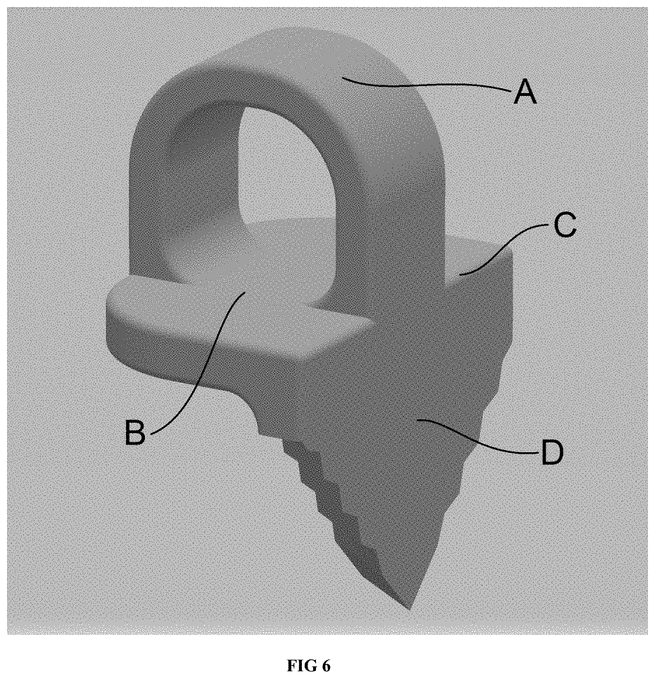

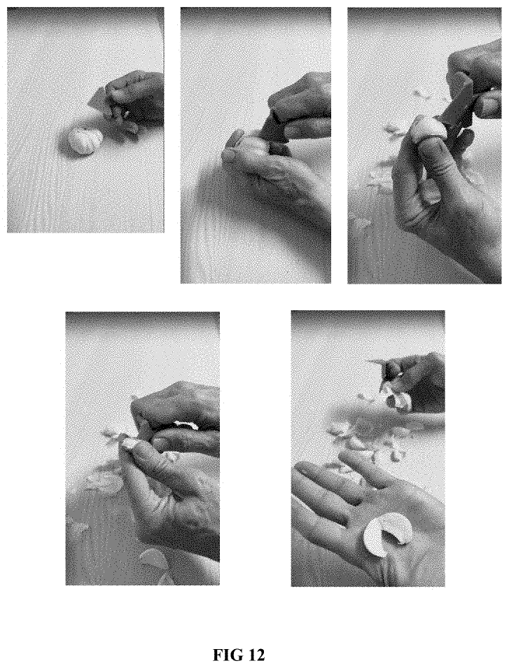

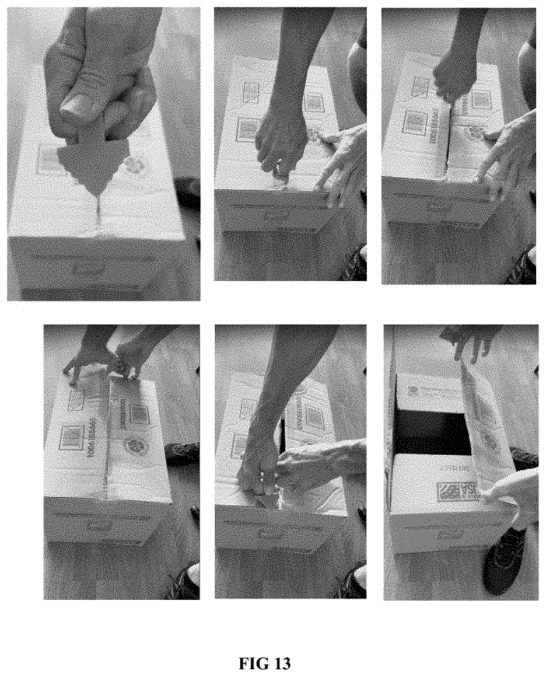

As shown in the picture, a front view of the multi-purpose cutting device or ring (FIG. 1), on the top of the piece, the ring or arch (FIG. 2a, FIG. 3a, FIG. 6a) attached to the support base (FIG. 2A, FIG. 3B, FIG. 5A, FIG. 6A). Just below the end of the ring you will find the blade (FIG. 1B, FIG. 2B, FIG. 3d, FIG. 5C, FIG. 6c), the blade, in this case have V shape (FIG. 1B, FIG. 2c), which is sharp on its lower inner edge, and it will always remain towards the inside of the fingers (FIG. 12, FIG. 13).

In the (FIG. 2) is best defined where the blade is attached to the support base (FIG. 3c, FIG. 5a), and you can also see the back of the cutting blade (FIG. 2b), which is attached to the support base that holds the ring (FIG. 6d), the ring create a balance and give space to the index finger to have a better grip.

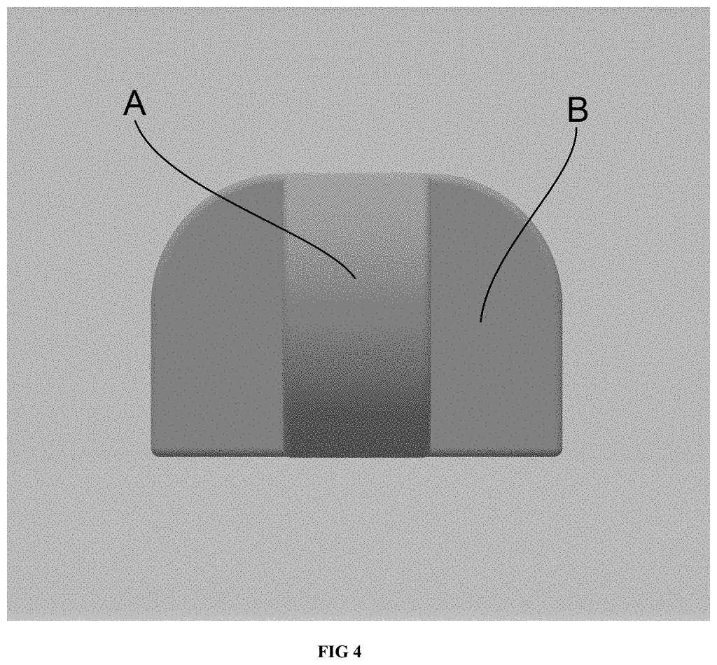

A single piece makes up this cutting device as can be seen in (FIG. 3), the ring at the top of the base (FIGS. 1, 2, 3, 4a), cross the support base (FIG. 3a, FIG. 4a, FIG. 6a), allows a better adjustment of the finger to the cutting device (FIG. 12). The ring that is attached to the support base (FIGS. 1, 2,3, 6a), provide strength and stability and works as a retaining wall. The support base (FIG. 3b, FIG. 4b, FIG. 5b, FIG. 6b), is the platform of the cutting apparatus and the multi-purpose ring, being in the center of the piece (FIGS. 3, 4, 5, 6b), allows you to have better balance, more comfort, better stability, more strength, support and better pressure on the cutting blade. On the other side of the union of the ring with the base, there is the 90 degree bend (FIG. 3).

A top view shows the upper part of the ring and support base (FIG. 4), the arch shape that cross the base (FIGS. 3, 4, 6) ensures that the finger has comfort and firmness when using the cutting device (FIGS. 12, 13), the support base (FIGS. 3, 4, 5, 6b), is the center of the cutting unit, where the finger or the second phalanx of the index finger rest (FIGS. 12, 13) the base holds the ring (FIGS. 1, 2, 3, 4, 6), and in one side has the cutting blade (FIG. 1B, FIG. 2B, FIG. 3c, FIG. 5a, FIG. 6d), to which the base provides of firmness, stability and pressure, when performing the cut (FIG. 12, FIG. 13).

The lower view of the cutting ring (FIG. 5) shows the lower face of the support base (FIGS. 3, 4, 5, 6b), also the area where the base joins with the blade (FIG. 5) and the area where the cutting edge is located (FIG. 5), the cutting edge (FIG. 3c, 5a) can have different forms as desired.

A perspective of the side of the piece (FIG. 6), “left position” gives us a general idea of the cutting device or multi-purpose ring, the ring in the center has the support base (FIGS. 3, 4, 5, 6b), which cross the base of the ring (FIGS. 3, 4, 6), giving firmness, balance and pressure to the cutting blade (FIG. 1B, FIG. 2B, FIG. 3d, FIG. 5C, FIG. 6d), the ring (FIGS. 1, 2, 3, 4, 6a), prevent the finger from suffering with the pressure it is exerted on the cutting blade when using the cutting device or multipurpose ring (FIG. 12, FIG. 13). The cutting blade, (FIGS. 1, 2B, FIG. 3c, FIG. 5a, FIG. 6d), always be used by placing the cutting blade inside the hand (FIGS. 12, 13), this ensures that the blade receives the highest pressure and better visibility when cutting is made (FIGS. 12, 13)

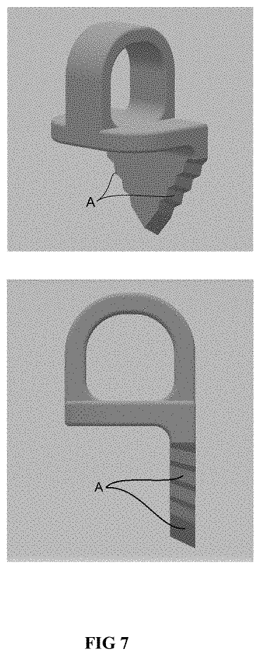

The basic version of the cutting device, (FIG. 7), the views allows us to define with clarity the edge of the piece, from two different perspectives (FIG. 3c, FIG. 5a), the edge of the blade of the cutting ring (FIG. 3c, 5a), the cutting blade edge, will always remain inside the blade for functionality and security issues (FIGS. 12, 13).

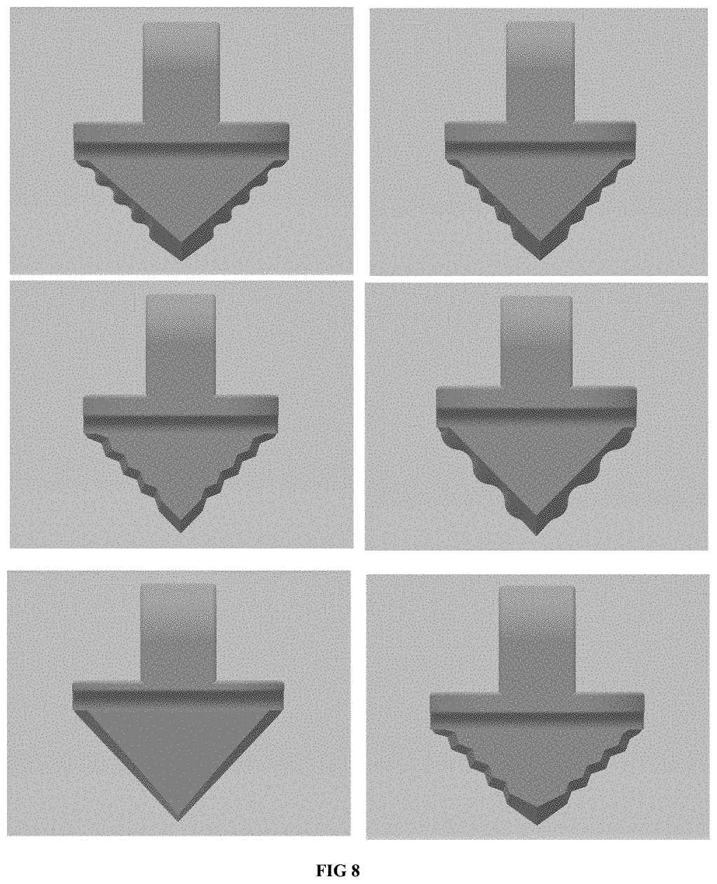

You can see six different drawings of cutting devices or multi-purpose rings (FIG. 8), the only difference between these parts is the cutting blade (FIG. 3c, 5a), all designs are one-piece shaped. The different shapes that are shown begin with a V shape (FIG. 8). Two cutting devices or multipurpose rings with the same blade design, both cut to the right and the left (FIGS. 12, 13), the side of the blades of this designs presents different shapes for a multipurpose tasks (FIGS. 12, 13), blades are different, ones are wavy, small pyramid-shaped tip, in the center of the leaf, you can see blades with several teeth in both sides (FIG. 8)

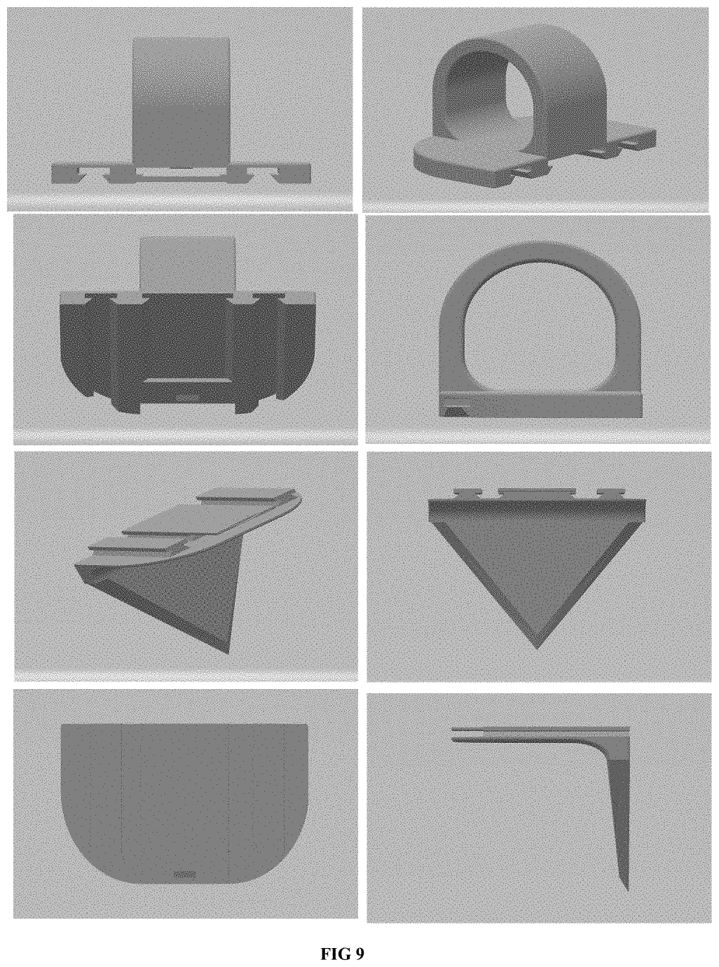

The image shows the two-piece version of the cutting device or multipurpose ring (FIG. 9), with a view of the two pieces in a detailed drawings. You can see how the two parts have a hook, to joined correctly in the front, side, bottom and perspective views of the multipurpose ring (FIG. 9), and the front, bottom and perspective view of the hook of the multipurpose ring (FIG. 9)

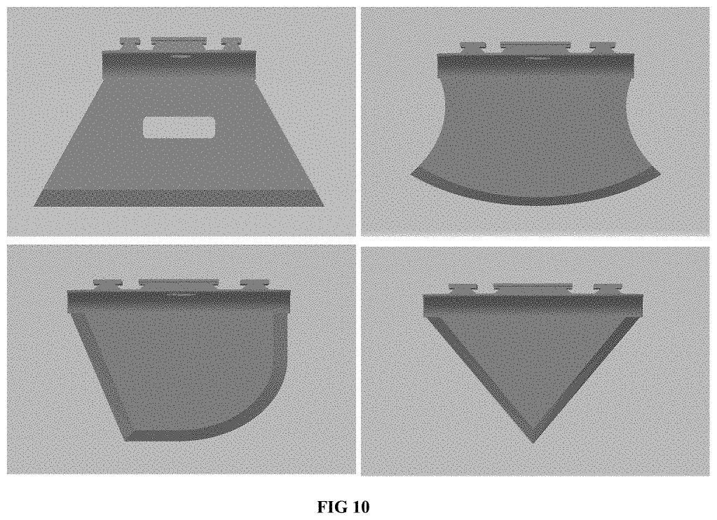

Four cut-sheet designs of the multipurpose ring (FIG. 10), a regular cutter blade, an axe shape, a knife shape and a V shape (FIG. 10), these drawings also included in the upper part of each one of them the front view of the hook.

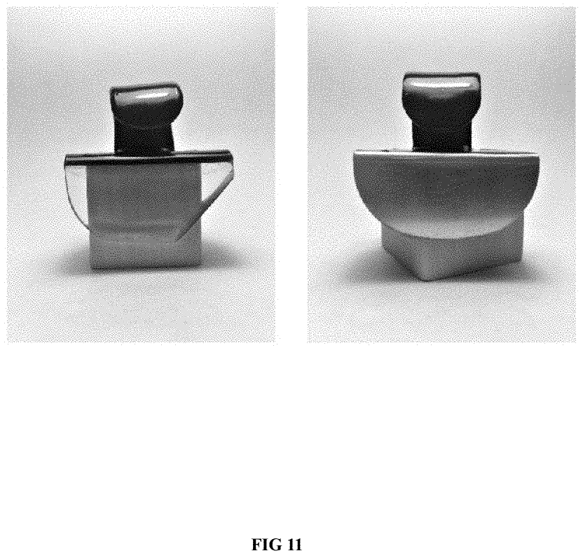

There are two different models of the cutting device or multipurpose ring (FIG. 11), and not only its cutting blade is different, (FIG. 11a), they are also made of different materials, and in addition the cutting devices or multi-purpose rings that are shown have the adjusting ring and support base covered by a rubber lining, the cutting device or multi-purpose ring on the left is made of acrylic and its cutting blade has a cut on its right side, which goes from the base to the bottom edge of the sheet (FIG. 11a), the cutting device or multipurpose ring on the right is made of resistant aluminum and its cutting blade is semicircular (FIG. 11b).

These images show the sequence of how garlic is peeled with the the cutting device (FIG. 12), since we take the garlic head we can use the cutting device, to easily extract the teeth from desired garlic (FIG. 12), making a cut at the back of the garlic clove with the cutting blade of the cutting device (FIG. 12), we manage to separate the clove of garlic in two (FIG. 12), this makes the garlic is peeled and cut at the same time (FIG. 12), this concept of peeling and cutting the garlic with the same action is totally new, what makes this tool faster in cutting and peeling garlic than all other products n the market, at least in the area of household products. The cutting device or multi-purpose ring does not need to be removed from the hand while the process is taking place (FIG. 12).

These images show the sequence of how to open a box with the the cutting device (FIG. 13), since we take the cutting device in our desired hand and put it on the finger, to easily get a good grid on the ring (FIG. 13), making a cut in the top of the box with the cutting blade of the cutting device or multipurpose ring (FIG. 13), we manage to cut the tape and open the box (FIG. 13), this makes the action faster at the same time safer (FIG. 13), this concept of open a box with a totally plastic cutter it's relatively new, and makes this tool the safer cutter in the market. The cutting device does not need to be removed from the hand while the process is taking place (FIG. 13).

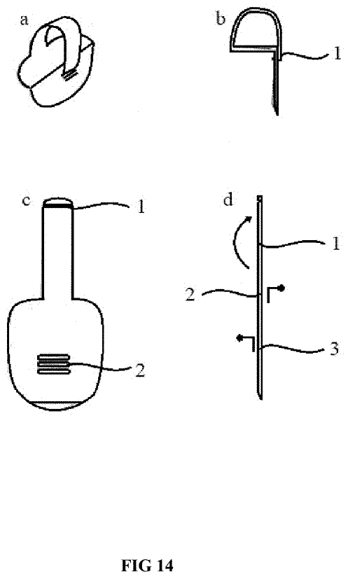

The drawings describe a version of cutting device or multipurpose ring (FIG. 14), which is made in one piece, has a fundamental difference with respect to the rest of the other versions, (FIGS. 14a, b), the adjustment ring in this version is longer than normal (FIGS. 14a, b), with the aim of adjusting the finger to the cutting device or multi-purpose ring, by means of a notch that has on the end of the adjustment ring (FIGS. 14b1, c1), and rectangular holes that are on top of the cutting blade (FIG. 14c2). The notch is inside the rectangular hole, securing the finger to the desired size (FIG. 14b1), this cutting device or multi-purpose ring is made in one piece, which upon receiving different bends in well determined, they form cutting device or multipurpose ring (FIGS. 14d1, 2, 3).

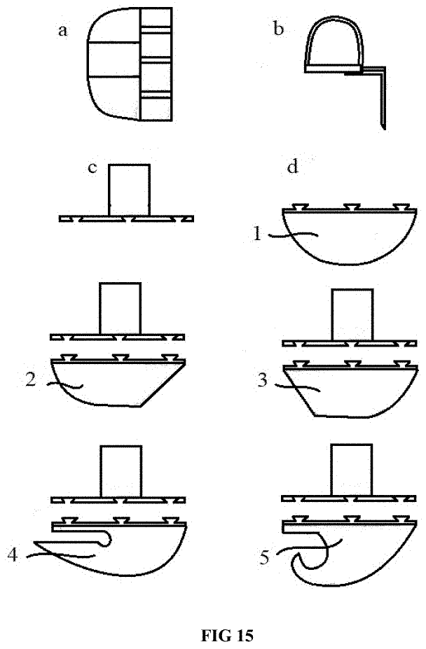

These are some of the drawings for the two-piece version of the multipurpose ring (FIG. 15). Top and front view of the joint between the two parts that make up the cutting device or multipurpose ring (FIGS. 15A, B), the fit of both pieces can be seen in the drawings on the side of the ring and the cutting blade (FIGS. 15C, D.1), the cutting blade of this image begins with a semicircular blade (FIG. 15D.1), blade design, with the cut to the right (FIG. 15 2), with the cut to the left (FIG. 15 3), two other designs of blades, a traditional can opener and a bottle opener (FIGS. 15 4, 5), same as the rest of the cutting blades they have on the upper part the design the second piece. In this case the ring (adjustment ring and support base).

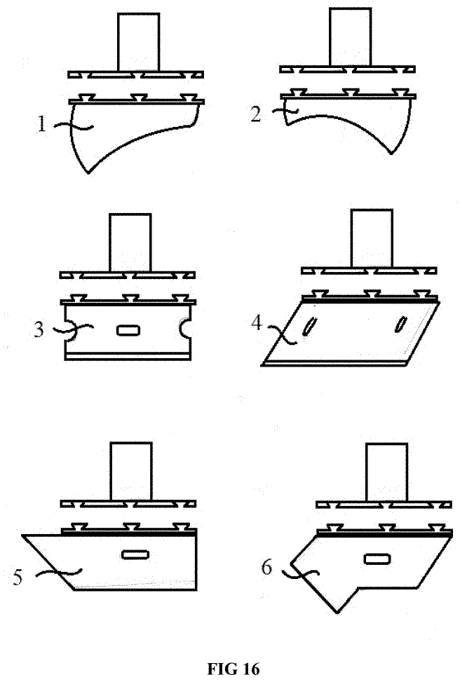

Six different designs of the different blades of multipurpose ring (FIG. 16), each design has on the top the other part of the ring that engages with the blade (FIG. 16), two equal designs, one with the cut to the right and another on the left, form two completely different cutting blades (FIGS. 16 1, 2), blade-shaped blades (FIG. 16 3), three different designs of of blades for different utilities. (FIGS. 16 4, 5, 6).

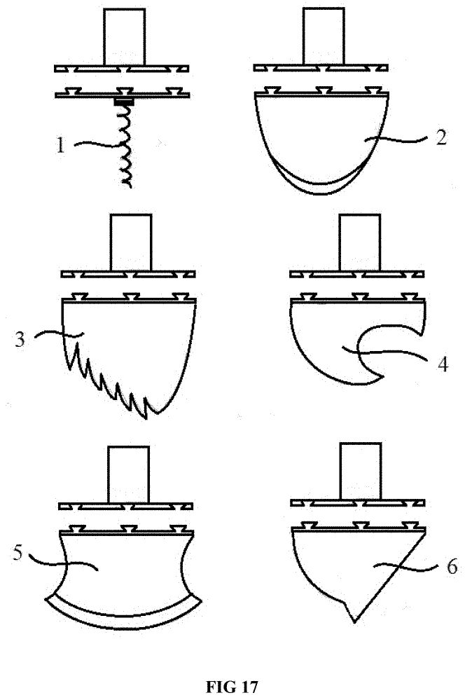

Six other models of the cutting blades of the multi-purpose ring (FIG. 17), a corkscrew and a vegetable or pizza cutter (FIGS. 17 1, 2), blade with saw shape and a cutting blade with a design that simulates a hook (FIGS. 17 3, 4), blade shaped like an ax, this cutting blade and a combination are presented of three blades in one, from left to right, -semicircular, triangle tip and lateral cut (FIGS. 17 5, 6).

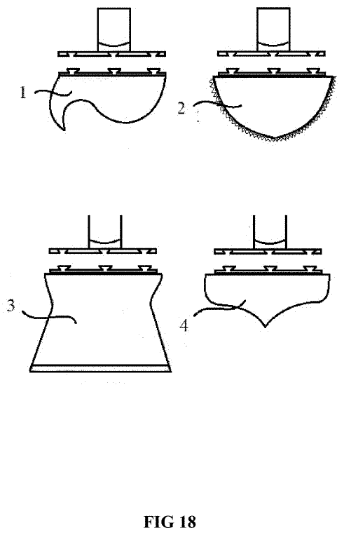

Four cut-sheet designs of the cutting device or multipurpose ring g (FIG. 18), a small hook on the end left of the blade and a larger and fully serrated blade (FIGS. 18 1, 2), with large size and spatula shape It shows this sheet in company of a blade with design of point of Heart (FIGS. 18 3, 4), these drawings also carry included in the upper part of each one of them, the ring, which is the second part that forms the piece.

The invention claimed is:

1- A cutting device or multi-purpose ring.

2- The cutting device of the claim 1. A cutting device is divided into three parts, ring, a flat base and a cutting blade.

3- The cutting device of the claim 1. Refers to an arch or ring which cross the base for the middle, the ring can have 3 different sizes in many cases.

4- The cutting device of the claim 3. The arch or ring can have a plastic protection that covers even the base and 1% of the blade; and in some cases the whole piece will be plastic and will only have the lining as extra if necessary.

5- The cutting device of the claim 1. The base holds the entire piece, in one side the ring and in the other the blade, the ring is located in the middle of the base and the cutting blade is located in one of the edges.

6- The cutting device of the claim 5. Between the arch and the cutting blade, the base forms a horizontal platform to give better stability.

7- The cutting device of the claim 5. In some cases the platform will have a letter on the blade side to identifies the size of the ring, the side of the ring always will be polished to avoid any irregularities that may affect product handling.

8- The cutting device of the claim 1. The cutting blade on the side of the platform give a better vision and stability, the blade can have different shapes and designs, it covers the entire side of the base.

9- The cutting device of the claim 8. Depending on the design and the will of the user, the blade can be used in many different angles. Half, or the whole blade.

10- The cutting device of the claim 8. The blade designs varies depending on the needs and the innovations that the concept allows to include.

11- The multipurpose ring of the claim 1. A ring with a base that have a hook and a blade with a base with a hook join to form a single piece or multipurpose ring.

12- The multipurpose ring of the claim 10. The the ring with the hook can have different sizes in some cases, the letter that identifies it will be pierced in the upper part of the base.

13- The multipurpose ring of the claim 10. The blade that is attached to a base with a hook can have infinite forms and shapes, the blade will have infinite designs that respond to different uses, while the ring only varies in size but almost never its design.

14- The multipurpose ring of the claim 1. A ring and a blade join to form a single piece or multipurpose ring through a hook that allows a safe, stable and resistant union.

15- The multipurpose ring of the claim 1. The hook allows blades to be safely and easily exchanged.

16- The multipurpose ring of the claim 1. The two parts that make up this piece will be made of metal in 90% of cases.
